(19) United States
(12) Patent Application Publication
(10) Pub. No.: US 2024/0152826 A1
(43) Pub. Date: May 9, 2024

(54) TRAVEL DISTANCE CALCULATION AND TASK SELECTION WITH INTELLIGENT BUFFERS

(71) Applicant: SAP SE, Walldorf (DE)

(72) Inventor: Markus Puchta, St. Leon-Rot (DE)

(73) Assignee: SAP SE, Walldorf (DE)

(21) Appl. No.: 17/983,278

(22) Filed: Nov. 8, 2022

(51) Int. Cl. G06Q 10/04; G06Q 10/06; G06Q 10/08

(52) U.S. Cl. CPC G06Q 10/047; G06Q 10/0633; G06Q 10/08

(57) ABSTRACT

After receiving a new task which specifies traveling from a first source bin to a first target bin, a computer-implemented method can select a task which specifies traveling from a second source bin to a second target bin, calculate a connecting distance to the new task measured from the second target bin to the first source bin, and compare the connecting distance to the new task with connecting distances to candidate tasks of the selected task. Responsive to determining that the connecting distance to the new task is smaller than the connecting distance to one of the candidate tasks, the method can update a successor list associated with the selected task. Responsive to completion of the selected task, the method can select a successor task from the successor list to execute. The successor task has the shortest connecting distance among the candidate tasks of the selected task.

### BACKGROUND

Path planning is generally performed to determine a travel path for a worker or machine (e.g., a semi-autonomous robot) through an area (e.g., a warehouse, a hospital, etc.). The area through which travel is planned may be referred to as a managed space. A planned path can be calculated based on data describing or defining the managed space. Path planning can determine where obstacles (e.g., walls, support structures, machines, fixtures, storage bins, etc.) are within the managed space, and tried to identify a path that avoids the obstacles.

Work tasks (or simply “tasks” hereinafter) can be created to define the travels in the managed space. Generally, a task can specify traveling from one location (or “source location”) to another location (or “target location”) within the managed space. For example, the task may require a worker or a machine to transport an item from one storage bin (or “source bin”) to another storage bin (or “target bin”). Depending on the physical layout of the managed space, it is possible to have multiple paths that link the source location to the target location. To improve efficiency and reduce carbon footprint, it is desirable to choose the shortest path for the travel. For a managed space that has numerous storage locations arranged in a complex layout, finding the shortest paths between any two locations in the managed space can be very computationally expensive. Further, when there are many tasks, the completion of one task (or “predecessor task”) can immediately trigger the start of another task (or “successor task”). In such circumstances, which successor task is triggered upon the completion of a predecessor task can also affect the travel distance and thus the overall operating efficiency. To minimize the time delay, the successor task is desirably determined instantaneously or in real-time upon the completion of the predecessor task. Accordingly, room for improvement exists for more efficient determination of the shortest path between any two locations in the managed space, and real-time, more intelligent selection of successor tasks upon completion of predecessor tasks.

### BRIEF DESCRIPTION OF THE DRAWINGS

FIG. 1 is a schematic illustration of an example layout model of a managed space and travel paths between two locations in the managed space.

FIG. 2 is an overall block diagram of an example system for a managed space, wherein the system uses intelligent buffers to support fast calculation of travel distances and task selections for the managed space.

FIG. 3 depicts four example data buffers that store pre-calculated distances for a managed space.

FIG. 4 is a flowchart illustrating an example overall method of generating and updating data buffers of FIG. 3.

FIG. 5 is a flowchart illustrating an example overall method of calculating travel distances between a source bin and a target bin located in a managed space.

FIG. 6 is a flow diagram depicting different phases of a task and example actions occurring in different phases of the task.

FIG. 7 depicts two example data buffers that store pre-determined successor lists for task management in a managed space.

FIG. 8 is a flowchart illustrating an example overall method of handling a new task.

FIG. 9 shows flow diagrams illustrating methods of handling existing tasks.

FIG. 10 is a block diagram of an example computing system in which described embodiments can be implemented.

FIG. 11 is a block diagram of an example cloud computing environment that can be used in conjunction with the technologies described herein.

### DETAILED DESCRIPTION

### Example 1—Overview of Managed Space and Travel Paths

A managed space can have a physical layout, which specifies x-y coordinates of objects (e.g., storage bins, workstations, obstacles, etc.), attributes of pathways (e.g., start and end point of each pathway, travel direction of each pathway, etc.), etc. The physical layout can be described in one or more files stored in a database. The managed space can be modeled as a network to determine a path through the managed space. The network can include a plurality of nodes that define intersections of permissible pathways in the managed space. Instead of defining the managed space in terms of obstacles (where a path cannot be), the managed space can be defined in terms of permissible pathways (the areas where a path can be). The definition of permissible pathways can reduce the computational overhead in determining a path for a given task. Additionally, determining a path with a managed space definition based on permissible pathways can allow for increased flexibility in defining the pathway, which results in increased efficiency in the management of the managed space. One example improvement is the ability to calculate a path distance, allowing the management of the managed space to account for expected distances and corresponding expected times to complete tasks.

The permissible pathways can define discrete areas of the managed space where travel through the managed space is possible and permitted. Travel is possible where a pathway exists. The type of travel possible on any given pathway can be further defined with parameters that can add constraints on how travel can be accomplished on the given pathway. For example, a pathway may have an associated or corresponding width, direction of travel (e.g., a one-way path), be restricted to access by a certain resource type (e.g., some equipment is permitted and others are not due to size or weight), etc. Any number of constraint parameters can be created and associated with the pathways.

The permissible pathways and the nodes connecting the pathways can define a network within the managed space. Travel distance between any two locations in the managed space can be calculated based on the network. In some circumstances, the managed space can include a plurality of storage bins (or simply “bins”) that are spatially distributed. As described below, the bins can be assigned to some of the pathways which can also be referred to as aisles in certain circumstances.

Further, tasks can be created that require traveling in the managed space. For example, a task can specify traveling from one location (or “source location”) to another location (or “target location”) within the managed space. Depending on the physical layout of the managed space, it is possible to have multiple paths that link the source location to the target location. In the following, a “source bin” is used to represent a source location and a “target bin” is used to represent a target location, although it should be understood that the source and/or target locations can be represented by fixtures or objects other than bins.

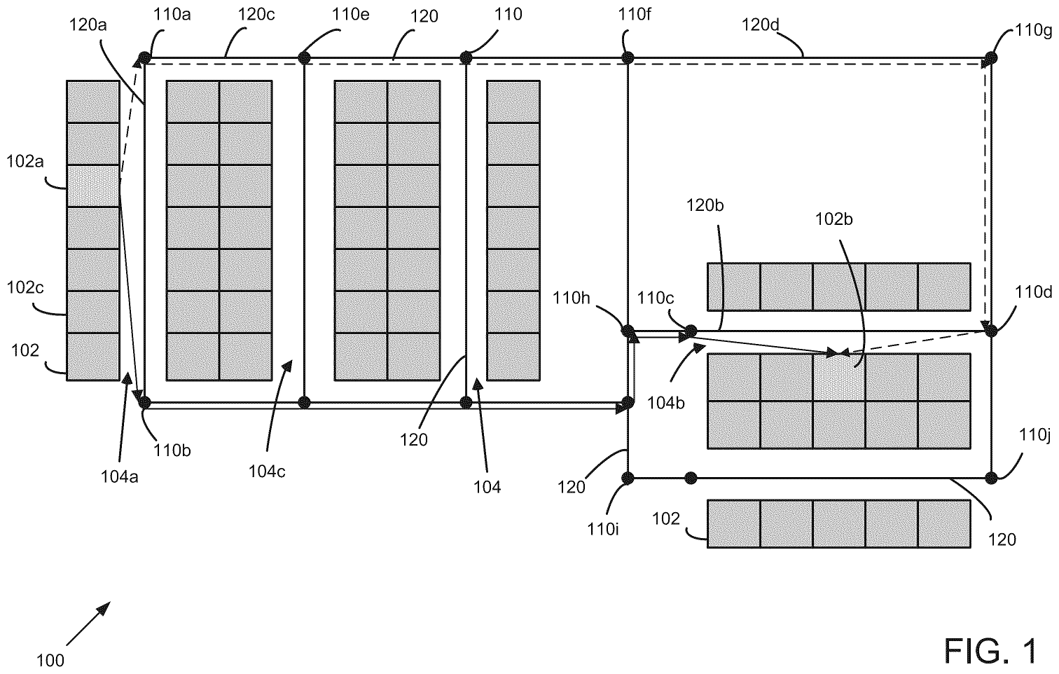

As an example, FIG. 1 depicts the layout model of a managed space 100 that includes a plurality bins 102 that are spatially distributed. The bins 102 can be assigned to and arranged by the sides of a plurality of aisles 104. The managed space 100 includes a plurality of permissible pathways 120 (including 120a, 120b, 120c, etc.) and a plurality of nodes 110 (including 110a, 110b, 110c, etc.) located at the intersections of the pathways 120. As described herein, each pathway 120 connects two nodes 110. The depicted layout model can be generated from master data of the managed space, which generally indicates the x-y coordinates of the bins 102 and nodes 110.

In the depicted example, each aisle can define a corresponding pathway. For example, the aisle 104a defines a pathway 120a connecting two nodes 110a and 110b, the aisle 104b defines a pathway 120b connecting two nodes 110c and 110d, etc. The two nodes connected by a pathway defined by an aisle can also be referred to as entry nodes and/or exit nodes of the aisle, depending on the travel direction of the aisle. For example, if the aisle 104a only allows one-way travel from 110a to 110b, then the pathway 120a has only one entry node 110a and one exit node 110b. On the other hand, if the aisle 104a allows two-way travel, then either 110a or 110b can be used as an entry node while the other node (110b or 110a) can be used as an exit node, or alternatively, each of the nodes 110a/110b can serve as both an entry node and an exit node (e.g., a worker or a machine can enter and exit the aisle 104a from the same node 110a or 110b).

As depicted in FIG. 1, some pathways 120 are not defined by the aisles 104. For example, some pathways can connect between entry and/or exit nodes corresponding to different aisles (e.g., the pathway 120c connects two nodes 110a and 110e which represent entry/exit points of two neighboring aisles 104a, 104c, respectively). As another example, some pathways can connect nodes that are not entry or exit node corresponding to an aisle (e.g., the pathway 120d connects two nodes 110f and 110g, neither of which is an entry or exit node of an aisle).

As an example, FIG. 1 also shows two plausible or candidate travel paths between a source bin 102a and a target bin 102b that are located at two different aisles 104a, 104b (both aisles are assumed to permit two-way travel in this example). The first path, as indicated by the dashed arrows, starts from the source bin 102a and exits the aisle 104a from the exit node 110a. The first path then passes through some intermediate nodes (e.g., 110e, 110f, 110g, etc.) before entering the aisle 104b through the entry node 110d, and finally arrives the target bin 102b. The second path, as indicated by the solid arrows, starts from the source bin 102a and exits the aisle 104a from another exit node 110b. The second path then passes through some intermediate nodes before entering the aisle 104b through another entry node 110c, and finally arrives the target bin 102b.

As described above, each task can specify traveling from a source bin to a target bin that are specific to the task. If the managed space is large and has a complex layout (e.g., with thousands of aisles and millions of bins), there can be many candidate travel paths between the source bin and target bin. To improve efficiency and reduce carbon footprint, it is generally desirable to choose the shortest travel path among all candidate travel paths for the task. When the number of candidate travel paths is large (e.g., hundreds or thousands), finding the shortest travel path between the source bin and the target bin can be very computationally expensive and time-consuming. The technologies described herein allow fast and efficient determination of shorted travel path between any two locations in the managed space.

Further, many tasks can be created for the managed space. The completion of one task (or “predecessor task”) can immediately trigger the start of another task (or “successor task”). In such circumstances, which successor task is triggered can also affect the travel distance and thus the overall operating efficiency of the managed space. To minimize the time delay, the successor task is desirably determined instantaneously or in real-time upon the completion of the predecessor task. In addition, there can be multiple workers or machines working on those tasks. Coordinating the assignment of tasks to different workers or machines can also complicate the selection of successor tasks. The technologies described herein allows real-time (e.g., within 100 ms or less in any of the examples described herein) and intelligent selection of successor tasks upon completion of predecessor tasks.

### Example 2—Example Task Management System for a Managed Space

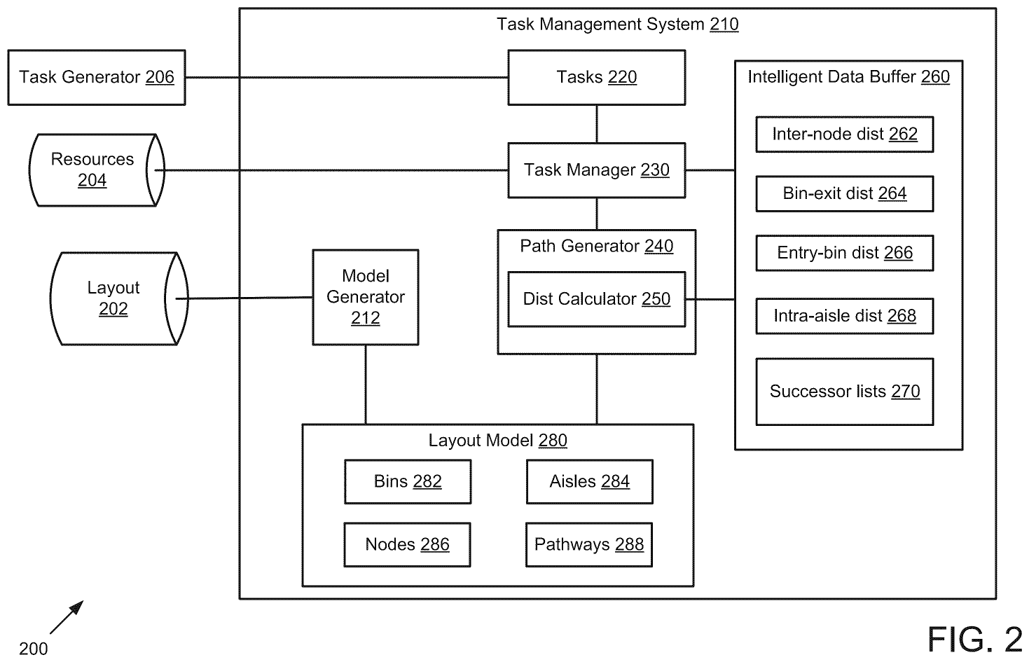

FIG. 2 is an overall block diagram of an example system 200 for a managed space. As described more fully below, the system 200 uses intelligent data buffers to support fast calculation of travel distances and task selections for the managed space.

As shown, the system 200 includes a task management system 210 configured to manage tasks for a managed space. The task management system 210 includes a model generator 212 which can generate a layout model 280 based on specification and/or description of a physical layout 202 of the managed space. As described further below, the layout model 280 can define a plurality of bins 282 assigned to a plurality of aisles 284. The layout model 280 can also include a plurality of nodes 286 that are located intersections of a plurality of pathways 288. As described above, some of the pathways 288 may be defined by corresponding aisles 284, whereas some of the pathways 288 may not be defined by aisles 284. As described herein, aisles 284 can be deemed as a subset of the pathways 288. Some of the nodes 286 may be exit and/or entry nodes for some of the aisles 284, whereas some of the nodes 286 may not be associated with aisles 284.

The task management system 210 includes a task manager 230 configured to receive tasks 220 from a task generator 206. Each task can specify or require traveling from one source location (e.g., a source bin) to a target location (e.g., a target bin). For each received task 220 specifying a source location and a target location, the task manager 230 can use a path generator 240 to generate a travel path from the source location to the target location. The path generator 240 includes a distance calculator 250, which can calculate distances for a plurality of routes connecting the source location to the target location. The path generator 240 can select the route that has the shortest distance as the travel path.

The task manager 230 can assign the received tasks 220 to one or more resources 204, which can be workers or machines. In some examples, the task manager can assign a received task 220 to a specific resource 204 by sending a message (e.g., via text messages, phone calls, a dedicated message application, or the like) wirelessly to an electronic device (e.g., a smartphone or the like) of the specific resource 204. The message can instruct the specific resource 204 to travel from the source location to the target location specified in the received task 220 according to the travel path determined by the path generator 240.

The task manager 230 can also be configured to determine successor tasks for each existing task. This existing task can also be referred to a predecessor task for the successor tasks. As described herein, the existing tasks refer to any received tasks 220 that have not been completed by the resources 204. As described further below, an existing task can be pending (not started) or executing (started but not completed).

The task manager 230 can also be configured to determine the successor tasks 270 to minimize connecting distances. As described herein, a connecting distance refers to a travel distance from a predecessor task's target location to a successor task's source location (also referred to as a “connecting path”). Upon the completion of a predecessor task, the resource working on the predecessor task is located at the predecessor task's target location. To start a successor task, the resource must travel (along the connecting path) to the successor task's source location. Thus, minimizing the travel distance from the predecessor task's target location to the successor task's source location can improve the operation efficiency and reduce carbon footprint.

As described herein, the task manager 230 can use the path generator 240 to determine the connecting path from the predecessor task's target location to the successor task's source location. In other words, the task manager 230 creates a phantom “connecting task” which specifies traveling from the predecessor task's target location to the successor task's source location. For this connecting task, the predecessor task's target location becomes the source location of the connecting path and the successor task's source location becomes the target location of the connecting path.

As described above, determining the travel path between two locations in the managed space can be computationally expensive and time-consuming. This problem exists not only for determining the travel path for each received task 220, but also for determining the connecting path for making a transition from a predecessor task to a successor task.

In any of the examples described herein, generation of travel path and determination of successor tasks can be performed efficiently by using intelligent data buffers 260, which can include a precalculated inter-node distance data buffer 262, a precalculated bin-exit distance data buffer 264, a precalculated entry-bin distance data buffer 266, a precalculated intra-aisle distance data buffer 268, a successor lists data buffer 270, etc. Examples of these precalculated data buffers are described further below. Any of the data buffers described herein can be in the forms of tables, views, spreadsheets, or the like. The data buffers can be stored in memory (such as cache memory) for fast data retrieval. In some circumstances, the precalculated data buffers can be persisted to disks or other storage medium.

In practice, the systems shown herein, such as system 200, can vary in complexity, with additional functionality, more complex components, and the like. For example, there can be additional functionality within the task management system 210. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 200 and any of the other systems described herein can be implemented in conjunction with any of the hardware components described herein, such as the computing systems described below (e.g., processing units, memory, and the like). In any of the examples herein, the tasks, distances, nodes, pathways, and the like can be stored in one or more computer-readable storage media or computer-readable storage devices. The technologies described herein can be generic to the specifics of operating systems or hardware and can be applied in any variety of environments to take advantage of the described features.

### Example 3—Example Framework for Calculating Travel Distance in Managed Space

Using the example depicted in FIG. 1, an overall framework for calculating the travel distance between two locations in a managed space is described. In any of the examples described here, the distance between bins and/or nodes can be measured based on x-y coordinates of the bins and/or nodes. Additionally, the distance measurement can be based on Euclid metric and/or Manhattan metric.

Assume a task requires traveling from a source bin to a target bin. If the source bin and the target bin are located in the same aisle and the aisle allows traveling from the source bin to the target bin, then the travel distance between the source bin and the target bin can be simply calculated as the direct distance from the source bin to the target bin. For example, if the source bin is 102a and the target bin is 102c which are both located in the two-way aisle 104a, then the travel distance for this task is simply the direct distance between the source bin 102a and the target bin 102b.

On the other hand, if the source bin and the target bin are located in two different aisles (e.g., the source bin 102a and the target bin 102b are located in two different aisles 104a, 104b, respectively), or if the source bin and the target bin are located in the same aisle which does not permit direct traveling from the source bin to the target bin (e.g., the source bin 102a and the target bin 102c are located in the same aisle 104a, which only allows one-way travel from 110b to 110a), then the travel distance can be calculated as following.

First, one or two first distances (also referred to as “source-exit distances”) can be calculated (based on Euclid or Manhattan metric) for traveling from the source bin to one or two exit nodes of the aisle associated with the source bin (also referred to as the “source aisle”). The source aisle has two exit nodes if it allows two-way travel, thus resulting in two source-exit distances. On the other hand, if the source aisle is one-way only, it has only one exit node, thus resulting in only one source-exit distance. For example, two source-exit distances (from source bin 102a to exit node 110a, and from source bin 102a to exit node 110b) can be calculated if the source aisle 104a is two-way, but only one source-exit distance (from source bin 102a to either 110a or 110b) can be calculated if the source aisle 104a is one-way.

Second, one or two second distances (also referred to as “entry-target distances”) can be calculated (based on Euclid or Manhattan metric) for traveling from one or two entry nodes of the aisle (also referred to as the “target aisle”) associated with the target bin to the target bin. The target aisle has two entry nodes if it allows two-way travel, thus resulting in two entry-target distances. On the other hand, if the target aisle is one-way only, it has only one entry node, thus resulting in only one entry-target distance. For example, two entry-target distances (from entry node 110c to target bin 102b, and from entry node 110d to target bin 102b) can be calculated if the target aisle 104b is two-way, but only one entry-target distance (from either 110c or 110d to target bin 102b) can be calculated if the target aisle 104b is one-way.

Third, one, two, or four third distances (also referred to as “exit-entry distances”) can be calculated for traveling from one of the exit nodes of the source aisle to one of the entry nodes of the target aisle. If both the source aisle and the target aisle are two-way, then four exit-entry distances can be calculated between two exit nodes of the source aisle to two entry nodes of the target aisle, respectively. If both the source aisle and the target aisle are one-way, then only one exit-entry distance can be calculated between one exit node of the source aisle to one entry node of the target aisle. If the source aisle is two-way but the target aisle is one-way, then only two exit-entry distances can be calculated between two exit nodes of the source aisle and one entry node of the target aisle. Similarly, if the source aisle is one-way but the target aisle is two-way, then only two exit-entry distances can be calculated between one exit node of the source aisle and two entry nodes of the target aisle. For example, if both aisle 104a and 104b are two-way, then four exit-entry distances can be calculated: (1) from exit node 110a to entry node 110c; (2) from exit node 110a to entry node 110d; (3) from exit node 110b to entry node 110c; and (4) from exit node 110b to entry node 110d.

Depending on the layout model of the managed space, many candidate paths linking an exit node to an entry node can exist. For example, to travel from the exit node 110a to the entry node 110d, the travel path can pass through intermediate nodes including 110f and 110g, or alternatively, pass through intermediate nodes including 110h, 110i, and 110j, which has a longer travel distance. Desirably, a shortest path algorithm (e.g., the Dijkstra's algorithm, or the like) can be used to calculate the exit-entry distance between an exit node and an entry node by minimize the travel distance between the two nodes. Thus, as described herein, the exit-entry distance can also be referred to as the Dijkstra distance.

Fourth, route distances from the source bin to the target bin can be calculated by respectively summing one of the source-exit distances, one of the entry-target distances, and one of the exit-entry distances. As described above, there can be one, two, or four different route distances depending on the one-way or two-way configuration of the source aisle and the target aisle. As described herein, the shortest route distance can be selected as the travel distance from the source bin to the target bin.

For the circumstances that the source bin and the target bin are located in the same aisle but are opposite to the allowed one-way travel direction, the travel distance between the source bin and target bin can be calculated in the same way as described above by designating the same aisle as both the source and target aisles. For example, if the task requires traveling from the source bin 102a to the target bin 102c but the aisle 104a only allows one-way travel from 110b to 110a, the source-exit distance is the distance measured from the source bin 102a to the exit node 110a, the entry-target distance is the distance measured from the entry node 110b to the target bin 102c, and the exit-entry distance is the shortest distance (e.g., calculated based on the Dijkstra's algorithm, or the like) measured from the exit node 110a to the entry node 110b.

In some circumstances, a bin (which can be a source bin or a target bin specified in a task) may not be assigned to an aisle. In such cases, the node that is nearest to the bin can be assigned to the bin as an entry node (if the bin is a target bin) or an exit node (if the bin is a source bin). The distance between the bin and its nearest node can be considered as the source-exit distance (if the bin is a source bin) or entry-target distance (if the bin is a target bin). Then, the travel distance between the source bin and target bin can be calculated in the same way as described above.

### Example 4—Example Data Buffers Storing Pre-Calculated Distances

Desirably, to ensure operating efficiency and reduce delay, determination of a travel path between two locations should be instantaneous or substantially in real-time, e.g., within 100 ms or less. However, as noted above, for a managed space having a very complex layout, finding the shortest paths between any a source bin and a target bin can be computationally expensive. One plausible approach is to pre-calculate travel distances between all possible pairs of source bin and target bin and save such precalculated travel distances in a data buffer for fast retrieval. Thus, instead of calculating the travel distance on demand, the travel distance can be directly retrieved from the data buffer when needed. However, this approach may be impractical for a very large managed space which can have millions of bins. The number of travel paths between all pairs of bins is in the order of B 2, where B is the number of bins. Thus, if the managed space has one thousand bins, the number of travel paths can be one million, which can render the data buffer to be prohibitively large. Moreover, the managed space may from time to time add new bins, remove some of the bins, and/or shift locations for some of the bins. Any such configurational change would necessitate recalculation of the bin-to-bin distances, resulting in significant overhead and complexity.

As described herein, fast determination of a travel path between two locations can be achieved using intelligent data buffers (e.g., 260) which store precalculated inter-node distances (e.g., inter-node distance data buffer 262). As described herein, the inter-node distance data buffer (e.g., 262) can store precalculated travel distances between each pair of nodes in the layout model of a managed space. Generally, in the layout model of a managed space, the number of aisles is much smaller than the number of bins. For example, hundreds of bins can be assigned to a single aisle in the managed space. As a result, a managed space can have thousands of bins, but only tens of aisles. Each aisle has a maximum of two entry and/or exit nodes. Even with intermediate nodes that are not associated with the aisles, the number of nodes N can be several orders less than the number of bins B (i.e., N<<B). Thus, the number of travel paths between all pairs of nodes is in the order of N 2, which is significantly smaller than B 2.

The inter-node distance data buffer needs to be updated if there are changes in the layout model of the managed space that affect the inter-node distance between any pair of nodes. Such changes can include changes in number and/or location of nodes, changes in number and/or location of pathways connecting the nodes, and changes in travel direction (e.g., from two-way to one-way, or vice versa) of pathways. However, the change of physical layout (e.g., the distribution of aisles) of a managed space occurs much less frequently than changing the bins. As a result, the nodes and pathways in the layout model are relatively stable over time. Thus, in general, updating the inter-node distance data buffer also occurs infrequently.

It is noted that in the framework described above for calculating the travel distance from a source bin to a target bin, the most time-consuming part of the calculation is the third step for calculating the exit-entry distances because there can be many candidate paths linking an exit node to an entry node, and a shortest path algorithm (e.g., the Dijkstra's algorithm, or the like) needs to be performed to determine the shortest exit-entry distance. Thus, by pre-calculating inter-node distances and saving the results in a data buffer (e.g., 262), which has a much smaller size (in the order of N 2), the exit-entry distances can be retrieved directly from such data buffer instead of being calculated on-demand, thus substantially reducing the overall time to determine the travel path from a source bin to a target bin.

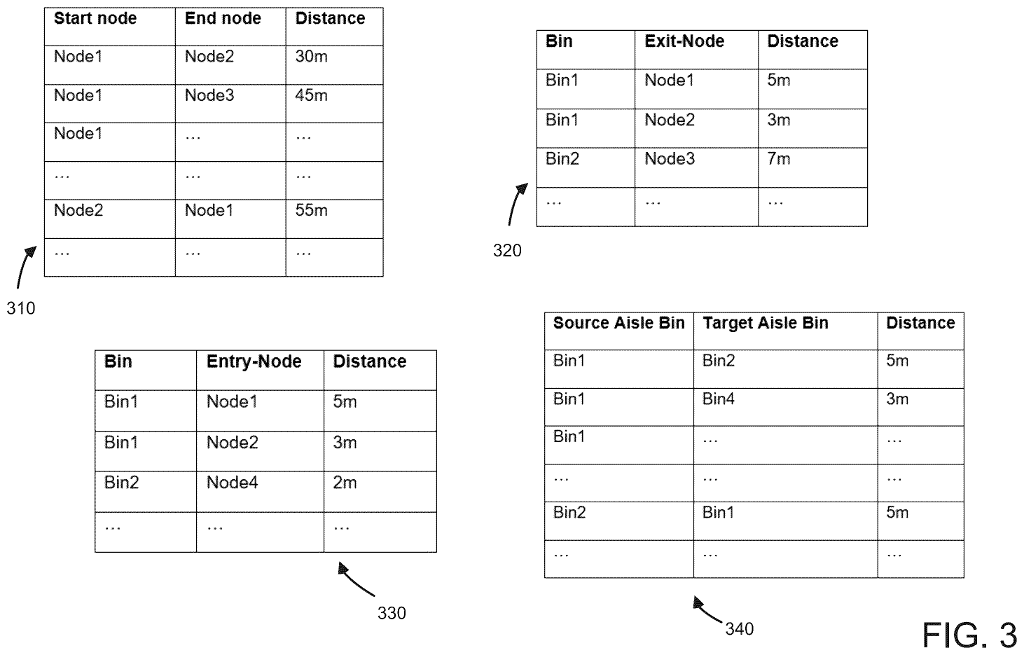

For illustration purposes, FIG. 3 shows an example table 310 representing an inter-node distance data buffer. As shown, the table 310 can have three columns: start node, end node, and distance. The start nodes can be any nodes in the layout model (e.g., 280) where a pathway can start from. For each start node, the end nodes can include any nodes in the layout model (other than the corresponding start node) where a travel path can lead to. The distance column stores the precalculated travel distances between the specified pairs of start node and end node. In the depicted example, when the start node is Node1, the end nodes can be Node2, Node3, etc., with corresponding travel distances of 30 m, 45 m, etc. The travel distances between two nodes can be different depending on the travel directions. For example, table 310 shows that the travel distance from Node1 to Node2 (e.g., 30 m) can be different from the travel distance from Node2 to Node1 (e.g., 55 m).

In certain examples, the table 310 can be sorted for fast data retrieval. For example, the start node column can be sorted based on predefined identifiers (which can be numerical and/or alphabetic) of the start nodes. For the rows corresponding to each specific start node, the corresponding end nodes can be sorted based on predefined identifiers of the end nodes. Thus, given an exit node and an entry node, a travel distance from the exit node to the entry node can be quickly retrieved from the distance column by looking up the table 310 (e.g., the row corresponding to the travel distance can be determined by finding the exit node in the start node column and finding the entry node in the end node column). Alternatively, the distance column can be sorted (e.g., from the smallest to the largest) based on calculated travel distances.

Although not as computationally demanding as calculating the exit-entry distances, the time for calculating the source-exit distances and entry-target distances can also be saved by storing precalculated distances in respective data buffers. For example, a bin-exit distance data buffer (e.g., 264) can store the precalculated distances from each bin to a corresponding exit node associated with the aisle to which the bin is assigned. Similarly, an entry-bin distance data buffer (e.g., 266) can store the precalculated distances for each bin, from an entry node associated with the aisle to which the bin is assigned, to the bin.

The needs to be updated if there are changes in the layout model of the managed space that affect any bin-exit distances. Such changes can include changes in number and/or location of bins, and changes in number and/or location of exit nodes. Similarly, the entry-bin distance data buffer needs to be updated if there are changes in the layout model of the managed space that affect any entry-bin distances. Such changes can include changes in number and/or location of bins, and changes in number and/or location of entry nodes. For efficiency, updating the bin-exit distance data buffer and/or entry-bin distance data buffer can be limited to those records that are affected by changes in the layout model. For example, if there is a change of an exit node (or an entry node), only bin-exit distances related to the exit node (or entry-bin distances related to the entry node) need to be updated.

As examples, FIG. 3 shows a table 320 representing a bin-exit distance data buffer and a table 330 representing an entry-bin distance data buffer. As shown, each table can include a bin column (identifying each bin), an exit-node or entry-node column (identifying exit-nodes or entry-nodes associated with each bin), and a distance column (storing precalculated bin-to-exit node distances or entry node-to-bin distances, respectively). Because each bin is associated with only one aisle, the number of entry and/or exit nodes corresponding to each bin is either one (for a one-way aisle) or two (for a two-way aisle). Thus, the maximum number of rows for the tables 320 and 330 is 2×B (which can be several orders smaller than B 2). In the depicted examples, the aisle associated with Bin1 is two-way. Thus, Bin1 has two exit nodes (Node1 and Node2) and two entry nodes (Node1 and Node2).

In certain examples, the tables 320 and/or 330 can be sorted for fast data retrieval. For example, the bin column can be sorted based on predefined identifiers (which can be numerical and/or alphabetic) of the bins. Alternatively, the tables 320 and/or 330 can be sorted based on predefined identifiers of the exit node or entry-node. Thus, given a source bin and an exit node, the source-exit distance can be quickly retrieved from the distance column by looking up the table 320. Similarly, given an entry node and a target bin, the entry-target distance can be quickly retrieved from the distance column by looking up the table 330.

In certain examples, the time for calculating the direct distance between two bins located in the same aisle can be saved by storing precalculated distances in an intra-aisle distance data buffer (e.g., 268). For example, an intra-aisle distance data buffer (e.g., 268) can store the precalculated distances between each pair of bins that are located in the same aisle and the travel between the pair is allowed (e.g., the aisle is two-way, or the travel direction follows the one-way direction of aisle).

The intra-aisle distance data buffer needs to be updated if there are changes in the layout model of the managed space that affect intra-aisle bin-to-bin distances. Such changes can include changes in number and/or location of bins, and changes in travel direction (e.g., from two-way to one-way, or vice versa) of pathways. For efficiency, updating the intra-aisle distance data buffer can be limited to those records that are affected by the changes in the layout model. For example, if there is a travel direction change or bin change in an aisle, only intra-aisle bin-to-bin distances corresponding to that aisle need to be updated.

As an example, FIG. 3 shows a table 340 representing an intra-aisle distance data buffer. As shown, the table 340 can include a source aisle bin column (identifying each potential source bin in an aisle), a target aisle bin column (identifying each potential target bin in the same aisle), and a distance column (storing precalculated direct distances from the identified source bins to the corresponding target bins). The number of bins in an aisle is much smaller than the total number of bins in the managed space. For simplicity, assuming the managed space has A aisles and the bins are equally distributed among the A aisles, the number of bins in each aisle is B/A. Thus, assuming all aisles allow two-way travel, the maximum number of rows in the table 340 is A×(B/A)² or B²/A (i.e., 1/A of B²). The number of rows in the table 340 can be even less if any of the aisles allows only one-way travel.

As described herein, the precalculated data buffers 310, 320, 330, and 340 are deemed “intelligent” data buffers because they represent a proper balance between calculation efficiency and memory usage. Specifically, usage of these data buffers can significantly reduce the computation time to calculate travel distances between any two locations because most of the intermediate results (e.g., the exit-entry distances, etc.) can be directly retrieved from the data buffers instead of being calculated on demand Meanwhile, the sizes of these data buffers are limited (e.g., the number of records in 310, 320, 330, and 340 are much smaller than B²). Further, as discussed above, these data buffers do not need to be frequently updated (e.g., for 310) or the update can be limited in scope (e.g., for 320, 330 and 340), thereby reducing the overhead of managing these data buffers.

### Example 5—Example Overall Method of Generating and Updating Intelligent Data Buffers

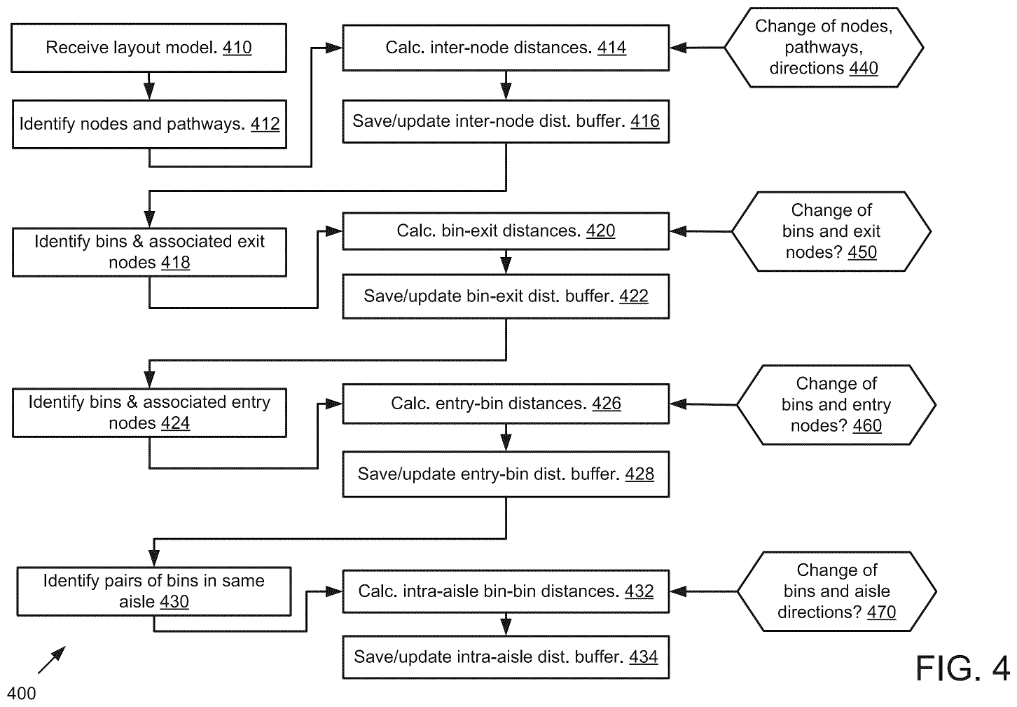

FIG. 4 is a flowchart of an example overall method 400 for generating and updating distance data buffers of FIG. 3, and can be implemented, for example, by the task management system of FIG. 2.

At 410, the method 400 receives a layout model (e.g., 280).

At 412, nodes and pathways defined in the layout model can be identified.

At 414, the method 400 can calculate inter-node distances between each pair of nodes defined in the layout model.

At 416, the calculated inter-node distances can be saved in an inter-node distance data buffer (e.g., 262), such as table 310, which can be sorted as described above.

At 418, the method 400 can identify bins defined in the layout model and (one or two) exit nodes associated with each bin.

At 420, the distance between each bin and its corresponding exit nodes can be calculated.

At 422, the calculated distances between the bins and exit nodes can be saved in a bin-exit distance data buffer (e.g., 264), such as table 320, which can be sorted as described above.

At 424, the method 400 can identify bins defined in the layout model and (one or two) entry nodes associated with each bin.

At 426, the distance between each bin and its corresponding entry nodes can be calculated.

At 428, the calculated distances between the bins and entry nodes can be saved in an entry-bin distance data buffer (e.g., 266), such as table 330, which can be sorted as described above.

At 430, the method 400 can identify pairs of bins that are located in the same aisle based on the layout model.

At 432, the distance between identified pairs of bins that are located in the same aisle can be calculated.

At 434, the calculated distances between pairs of bins that are located in the same aisle can be saved in an intra-aisle distance data buffer (e.g., 268), such as table 340, which can be sorted as described above.

Responsive to the detection of a condition 440 that the layout model has a change of nodes, pathways, and/or travel directions associated with the pathways, the method 400 recalculates the inter-node distances at 414 and updates the inter-node distance data buffer at 416.

Responsive to the detection of a condition 450 that the layout model has a change of bins and/or exit nodes, the method 400 recalculates the distances between bins and corresponding exit nodes at 420, and updates the bin-exit distance data buffer at 422.

Responsive to the detection of a condition 460 that the layout model has a change of bins and/or entry nodes, the method 400 recalculates the distances between bins and corresponding entry nodes at 426, and updates the entry-bin distance data buffer at 428.

Responsive to the detection of a condition 470 that the layout model has a change of bins and/or aisle directions, the method 400 recalculates the intra-aisle bin-bin distances at 432, and updates the intra-aisle distance data buffer at 434.

In some examples, the bin-exit distance data buffer, the entry-bin distance data buffer, and/or the intra-aisle distance data buffer can be optional. In such cases, the relevant steps 418-422, 424-428, and/or 430-434 can be optional.

The method 400 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example 6—Example Overall Method of Calculating Travel Distances Using Intelligent Data Buffers

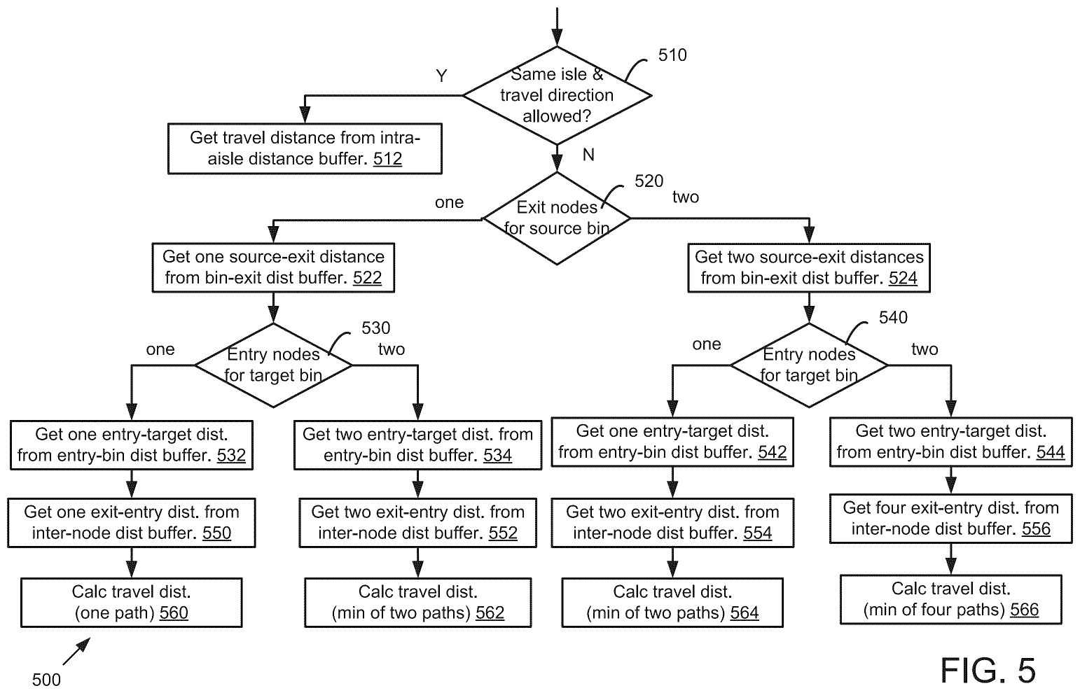

FIG. 5 is a flowchart of an example overall method 500 of calculating travel distances between a source bin and a target bin located in a managed space using intelligent data buffers, and can be performed, for example, by the distance calculator 250 of FIG. 2. The method 500 generally follows the overall framework for calculating the travel distance between two locations in a managed space, as described above.

At 510, the method 500 first check if the source bin and the target bin are in the same aisle, and if so, whether the direction of the aisle allows direct traveling from the source bin to the target bin within the aisle.

If the condition check at 510 returns yes, the method 500 can branch into 512 to look up and directly retrieve from the intra-aisle distance data buffer (e.g., table) the travel distance from the source bin to the target bin.

If the condition check at 510 returns no, the method 500 then proceeds to 520 to identify exit nodes for the source bin. If the source bin has one exit node (e.g., the source aisle is one-way), the method 500 can look up and retrieve one source-exit distance directly from the bin-exit distance data buffer (e.g., table 320) at 522. If the source bin has two exit nodes (e.g., the source aisle is two-way), the method 500 can look up and retrieve two source-exit distance directly from the bin-exit distance data buffer (e.g., table 320) at 524.

Next, the method 500 can proceed to 530 (if the source bin has one exit node) or 540 (if the source bin has two exit nodes) to identify entry nodes for the target bin. If the target node has one entry node (e.g., the target aisle is one-way), the method 500 can look up and retrieve one entry-target distance directly from the entry-bin distance data buffer (e.g., table 330) at 532 or 542, respectively. If the target node has two entry nodes (e.g., the target aisle is two-way), the method 500 can look up and retrieve two entry-target distances directly from the entry-bin distance data buffer (e.g., table 330) at 534 or 544, respectively.

Then, depending on the number of exit nodes associated with the source bin and the number of entry nodes associated with the target bin, the method can proceed to 550, 552, 554, or 556 to look up and directly retrieve respective one, two, two, or four exit-entry distances from the inter-node distance data buffer (e.g., table 310).

Finally, at 560 (one route from one exit node to one entry node), 562 (two routes from one exit node to two entry nodes), 564 (two routes from two exit nodes to one entry node), or 566 (four routes from two exit nodes to two entry nodes), one, two, two, or four route distances from the source bin to the target bin can be calculated by respectively summing one of the source-exit distances, one of the entry-target distances, and one of the exit-entry distances, and the shortest route distance can be selected as the travel distance from the source bin to the target bin.

As described above, if any of the bin-exit distance data buffer, the entry-bin distance data buffer, and/or the intra-aisle distance data buffer is optional, the corresponding distances (e.g., the source-exit distance, entry-target distance, direct intra-aisle bin-to-bin distance) can be calculated on demand, instead of retrieving from the corresponding data buffers.

### Example 7—Example Task Phases

Typically, many tasks can be generated for a managed space, and each task can require traveling from one task-specific source location to a task-specific target location. These tasks can be assigned to different resources (e.g., workers and/or machines). To improve operation efficiency, idle time of the resources should be minimized Thus, once a resource completes one task (or predecessor task), another task (or successor task) that has not been performed by other resources should be immediately assigned to that resource.

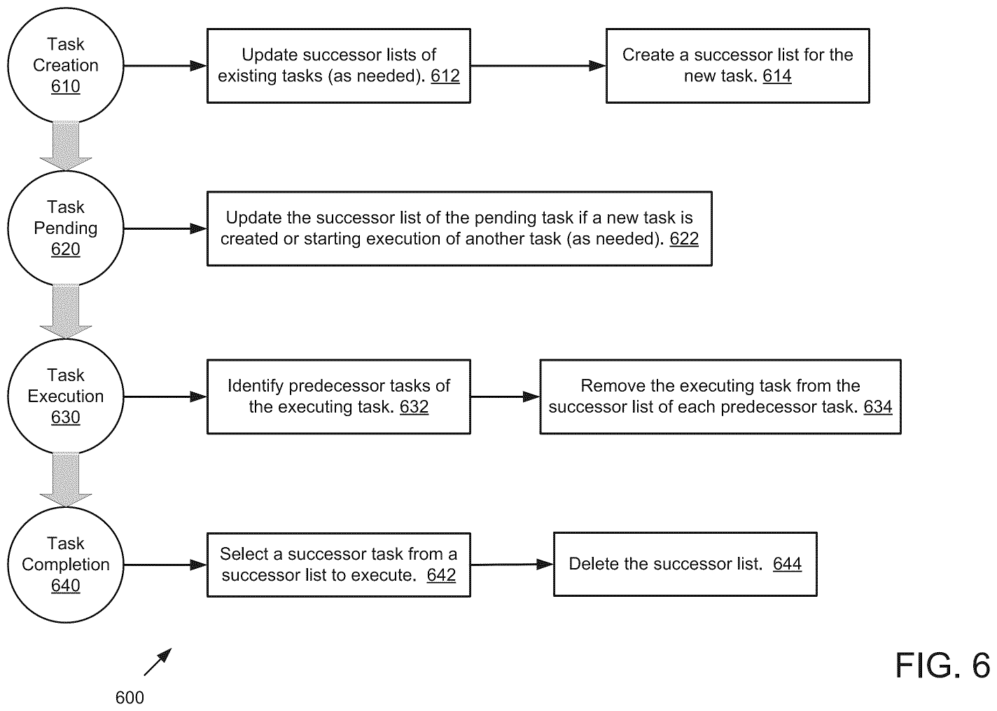

As illustrated in FIG. 6, a task can have four phases: task creation 610, task pending 620, task execution 630, and task completion 640. As shown in FIG. 2, tasks 220 be created externally (e.g., by the task generator 206) and received by the task manger 230 of the task management system 210. After being created, the task remains in the pending state until the task is assigned to a resource for execution. Executing the task causes the resource to travel from a source location to a target location specified by the task. The task can be removed after its completion, at which time the resource is at the target location specified by the task.

### Example 8—Example Execution-Dependent Successor Lists

Once a resource completes a predecessor task, the task manager 230 needs to determine which of the pending tasks should be selected as a successor task and assigned to the resource. As described above, to improve operation efficiency and reduce carbon footprint, the task manager 230 can choose the successor task that minimizes the connecting distance (i.e., the travel distance from a predecessor task's target location to the source location of a pending task). When there are many pending tasks to choose from, determining the successor task can be time-consuming. For example, even with the precalculated distance data buffers (e.g., 310-340) described above, if it takes 20 ms to calculate the connecting distance for one pending task and there are 50 pending tasks to choose from for the successor task, then the total time for determining the successor task can be over 1 second, thereby creating an undesirable time lag between the predecessor task and the successor task.

One potential solution to reduce the time for determining the successor task is to maintain a successor list for each task that is in execution phase. The successor list can identify a plurality of candidate tasks (among the pending tasks), ordered according to their connecting distances, that can be potentially selected as the successor task. Thus, upon the completion of a predecessor task, one of the candidate tasks that has the shortest connecting distance in the successor list and has not been started by other resources can be selected as the successor task for execution. The selected successor task can be assigned to the same resource who just completed the predecessor task, e.g., by sending a message to the resource with instructions to travel along a new travel path determined by the selected successor task.

For example, the start of a task T can trigger the task manager 230 to create a successor list of task T. Specifically, at the start of task T, the task manager 230 can calculate the connecting distance for each pending task, rank the calculated connecting distances in an ascending order, and select up to C candidate tasks that have the shortest connecting distances to the successor list of task T, where C can be a predefined number (e.g., C=5, 10, 20, etc.). Generally, C can be defined to be proportional to NR, where NR is the number of resources. For example, C can be defined as n×NR, where n is a predefined integer.

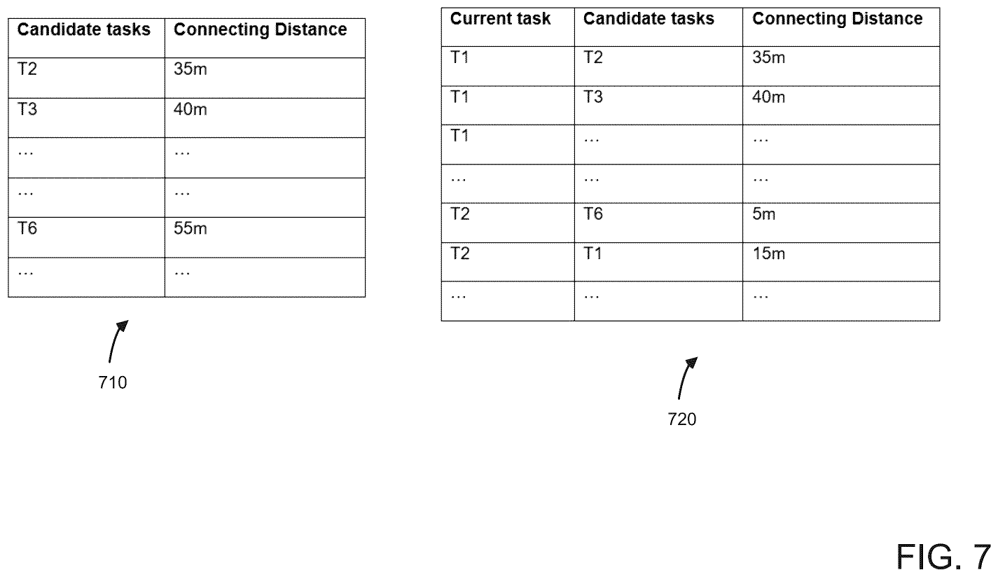

As an example, FIG. 7 shows a successor list 710 for a task T1, which includes a plurality of candidate task T2, T3, etc., ordered based on calculated connecting distances. Thus, upon the completion of task T1, task T2 can be selected as the successor task for T1 if task T2 has not been started by other resources. If, however, task T2 has been assigned to another resource, the next candidate task, e.g., T3, can be selected as the successor task for T1 if task T3 has not been started by other resources, and so on.

The successor lists for each executing task can be stored in the intelligent data buffer 230 (e.g., the successor lists 270). Because the connecting distances are precalculated and the candidate tasks are pre-sorted, the successor tasks can be determined immediately by looking up the data buffer storing the successor lists 270, instead of performing the calculation (which can be time consuming) at the completion of predecessor tasks.

Because the successor list 710 is created when task T1 is started, and it usually takes some time to complete task T1, that time is usually sufficiently long to allow the task manager 230 to generate the successor list 710. However, exceptions can occur when the time to complete T1 is so short that there may not be enough time to generate the successor list 710. Further, it can also happen that all candidate tasks in the successor list 710 are started by other resources so that no successor task is available upon the completion of task T1. These challenges exist because the successor list 710 is execution-dependent for two reasons: First, the creation of successor list 710 depends on the execution of task T1. Second, the successor task 710 remains static throughout the execution of task T1 (from start to completion).

### Example 9—Example Execution-Independent Successor Lists

An alternative solution to reduce the time for determining the successor task is to maintain a successor list for each task, regardless the task is a new task or an existing task, and regardless the task is pending or in execution phase. Specifically, for each newly created task, a successor list can be created for the new task. Meanwhile, the successor lists for existing tasks (in pending or execution phases) are updated, if necessary. The successor lists according to this approach are execution-independent because the creation of successor lists do not require execution of any tasks. Additionally, the successor lists can be updated dynamically as new tasks are generated and/or pending tasks moves to execution phases, as described more fully below.

As an example, FIG. 7 shows a master (or lumped) successor list 720 which includes a plurality of successor lists for all current tasks that are in either pending or execution phases. The successor list for each current task can be sorted based on connecting distances. For example, the current task T1 can have a corresponding successor list including T2, T3, etc., ordered according to the calculated connecting distances; the current task T2 can have a corresponding successor list including T6, T1, etc., ordered according to the calculated connecting distances; and so on. Similarly, the length of each successor list (e.g., C) can be predefined, e.g., to be proportional to NR, as described above. In other examples, the successor list for each current task can be stored in a separate table, instead of being stored in a lumped table as in 720.

The master successor list 720 (or separate successor lists for each current task) can be stored in the intelligent data buffer 230 (e.g., the successor lists 270). Because the connecting distances are precalculated and the candidate tasks are pre-sorted, the successor tasks can be determined immediately by looking up the data buffer storing the master successor list 720 (or separate successor lists), instead of performing the calculation (which can be time consuming) at the completion of predecessor tasks.

### Example 10—Example Task Management Actions on Successor Lists

In some examples, the execution-independent successor lists can be managed by the task manager 230. Such management can include various actions such as creating, editing, and/or deleting one or more of the successor lists. FIG. 6 shows some example actions that can occur in different phases of a task.

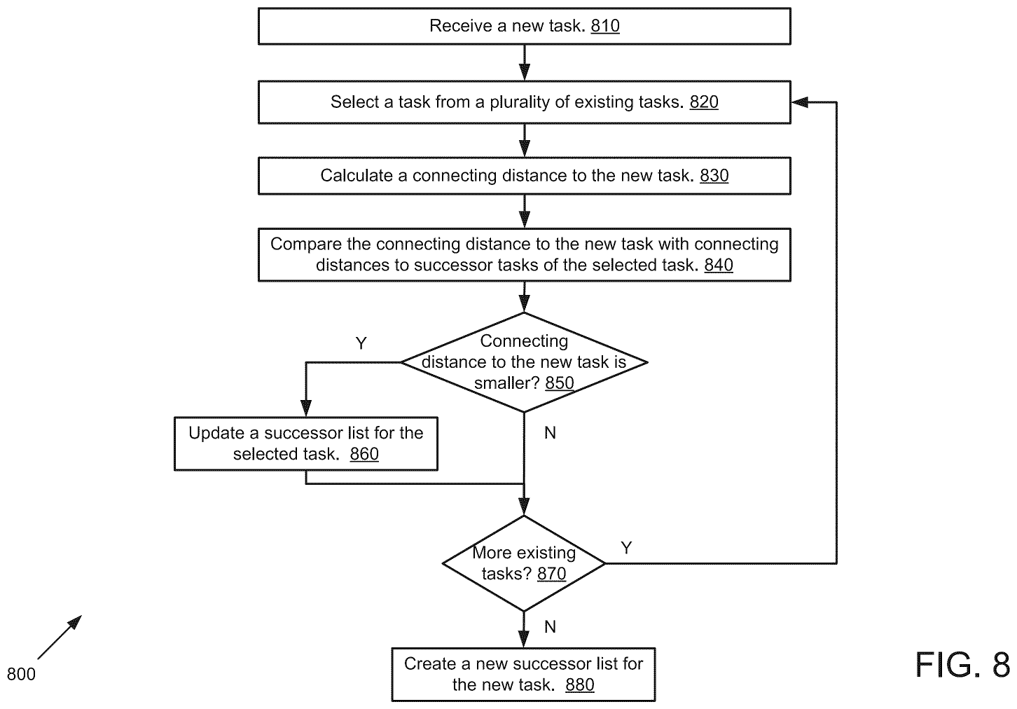

When a new task is created (e.g., at the task creation phase 610), the task manager can take the action 612 to update successor lists of existing tasks (which can be pending tasks or tasks in the execution phase), as needed (e.g., if the new task is determined to be one of the candidate tasks for any of the existing tasks). Additionally, the task manager can take the action 614 to create a successor list for the new task. Details of these actions are described further below with reference to FIG. 8.

For a pending task (e.g., at the task pending phase 620), the task manager can take the action 622 to update the successor list of the pending task, as needed, when a new task is created (e.g., if the new task is determined to be one of the candidate tasks for the pending task), or another task is started (e.g., if a candidate task of the pending task changes from the pending phase to the execution phase).

When a task enters the task execution phase 630, the task becomes an executing task. The task manager can take the action 632 to identify predecessor tasks of the executing task. Additionally, the task manager can take the action 634 to remove the executing task from the successor list of each predecessor task.

Upon the completion of a task (e.g., at the task completion phase 640), the task manager can take the action 642 to select a successor task from the successor list of the completed task to execute. Then, the task manger can take the action 644 to delete the successor list of the completed task.

### Example 11—Example Method of Handling a New Task

FIG. 8 is a flowchart of an example method 800 of handing new tasks, and can be performed, for example, by the task manager 230 of FIG. 2.

At 810, a new task is received by the task manager. The new task specifies traveling from a first source bin (SB1) to a first target bin (TB1).

At 820, the task manager can select a task from a plurality of existing tasks for processing (e.g., for the following steps 830-860). The selected task can be in the pending phase or execution phase. The selected task specifies traveling from a second source bin (SB2) to a second target bin (TB2).

At 830, the task manager can calculate a connecting distance to the new task. The connecting distance to the new task is measured from the second target bin TB2 to the first source bin SB1. Calculation of the connecting distance to the new task can be performed by the distance calculator 250 of FIG. 2 using the method 500 described above.

At 840, the task manager can compare the connecting distance to the new task with connecting distances to successor tasks of the selected task. As described herein, the candidate tasks of the selected task are chosen from the plurality of existing tasks that have not been executed based on ranking of their connecting distances (e.g., up to a predefined number of existing tasks that have the shortest connecting distances). As described above, the connecting distance to an existing task is measured from the second target bin TB2 to respective source bin of the existing task.

At 850, the task manager can check if the connecting distance to the new task is smaller than the connecting distance to one of the candidate tasks of the selected task.

If yes, the method can proceed to 860, where the task manager can update a successor list of the selected task. As described above, the successor list identifies the candidate tasks of the selected task. Such updating can comprise removing one of the candidate tasks of the selected task that has the largest connecting distance from the successor list and adding the new task to the successor list. For example, referring to table 720 in FIG. 7, for simplicity, let us assume the successor list for task T1 includes 10 candidate tasks (T2, T3, . . . , T11) ranked based on an ascending order of the connecting distances. If the connecting distance to the new task is smaller than the connecting distance to task T3, then T11 will be removed from the successor list for task T1, and the new task will be added to the successor list for task T1. For example, the new task can be inserted between candidate tasks T2 and T3 if the connecting distance to the new task is larger than the connecting distance to T2 so that the successor list for task T1 remains in the ascending order of the connecting distances. The updating performed at 860 can be the action performed at 612 and 622 depicted in FIG. 6 and described above.

If the condition check at 850 returns no, the method can proceed to 870 to check if any other existing tasks need to be processed.

If yes, the method can return to step 820 to select another existing task for processing (e.g., to repeat the steps 830-860).

Otherwise, the method can proceed to 880 to create a new successor list for the new task. As described herein, the new successor list identifies candidate tasks of the new task. The candidate tasks of the new task are chosen from the plurality of existing tasks that have not been executed (i.e., in pending phases) based on ranking of their connecting distances. In other words, existing tasks that are already in execution phase are not candidate tasks of the new task. Creating the new successor list at 880 can be the action performed at 614 depicted in FIG. 6 and described above.

### Example 12—Example Method of Handling Existing Tasks

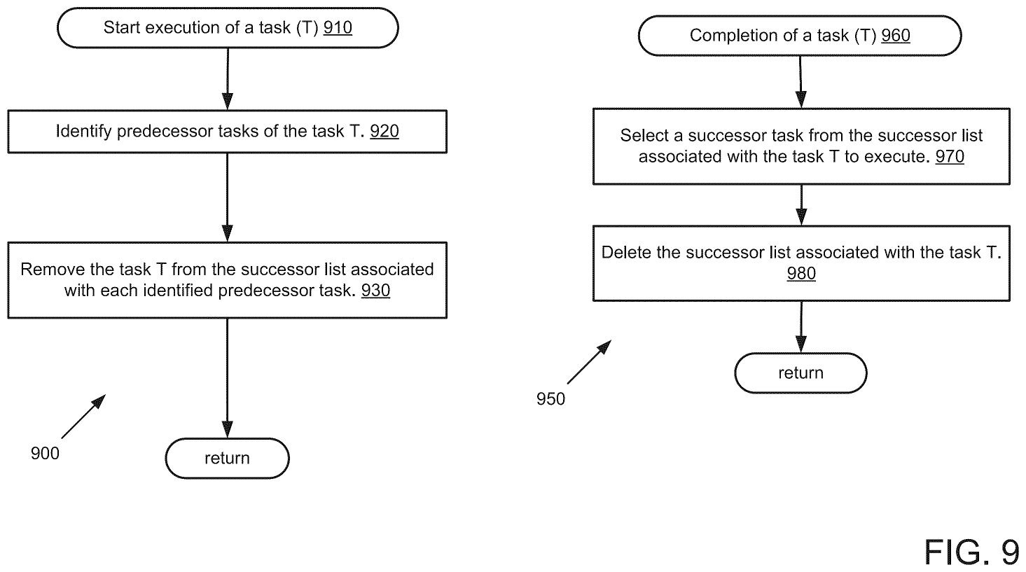

FIG. 9 flow diagrams illustrating methods for a task manager (e.g., 230) to manage the successor lists of existing tasks, including a method 900 to handle existing tasks that transit from the pending phase to execution phase, and a method 950 to handle existing tasks that enter the completion phase.

The method 900 begins at 910 when a task (denoted as T) is started for execution (e.g., task T is assigned to a resource to perform).

At 920, the task manager can identify all predecessor tasks of task T. As described herein, each predecessor task has an associated successor list which identifies task T as one of the candidate tasks for the predecessor task.

Then at 930, the task manager can remove task T from the respective successor list associated with each identified predecessor task.

In some examples, after removing task T from a successor list associated with a predecessor task, the task manager can replenish the successor list by finding another candidate task to the successor list (so that the number of candidate tasks in the successor list remains constant). In other examples, the task manager does not need to replenish the successor list after removing task T from the successor list (so that the number of candidate tasks in the successor list is reduced by one).

As a result, each executing task (e.g., task T) is removed from the successor lists of all of its predecessor tasks. Thus, all candidate tasks remained in those successor lists are in the pending state.

The method 950 begins at 960 when a task (denoted as T) is completed (e.g., when the resource undertaking the task reaches the target location specified by the task).

At 970, the task manager can select a successor task from the successor list associated with task T. As described herein, one of the candidate tasks that has the shortest connecting distance in the successor list and has not been started by other resources can be selected as the successor task for execution. In some examples, the selected successor task can be assigned to the same resource who just completed the task T, e.g., by sending a message to the resource with instructions to travel along a new travel path determined by the selected successor task.

As discussed above, any new successor lists created for new tasks only include pending tasks (see step 880 of FIG. 8), and any executing tasks are removed from successor lists of corresponding predecessor tasks (see method 900). Thus, the task manager can ensure that upon the completion of task T, all candidate tasks in the successor list associated with task T are in the pending phase.

At 980, the task manager can delete the successor list associated with task T after selecting the successor task. This step, which can be optional, can reduce the overall size of the successor lists data buffer (e.g., 270) and reduce the number of successor lists to be managed by the task manager.

### Example 13—Example Advantages

A number of advantages can be achieved via the technologies described herein. For example, fast determination of travel path between any two locations in a managed space can be achieved by using intelligent data buffers which store precalculated inter-node distances (and optionally, other distance measures such as bin-exit distances, entry-bin distances, and/or intra-aisle bin-to-bin distances, etc.). As described above, using such intelligent data buffers can achieve a good balance between calculation efficiency and memory usage.

Further, the technologies described herein allows real-time (e.g., within 100 ms or less) and intelligent selection of successor tasks upon completion of predecessor tasks. This can be achieved, e.g., by managing successor lists associated with all tasks received for the managed space. As described above, the successor lists can be dynamically managed during the full life cycle of the tasks (e.g., new successor lists are created upon the creation of new tasks, successor lists associated with existing tasks can be updated upon the creation of new tasks or starting execution of some tasks, the completion of tasks can cause deletion of corresponding successor lists, etc.). By storing the successor lists in the intelligent data buffer, the task management system described herein can instantaneously determine successor tasks which minimize connecting distances, thereby reducing resource idle time, improving operating efficiency, and reducing carbon footprint associated with the travels. Additionally, by using the successor lists, the task management system described herein can support multiple resources working simultaneously on a plurality of tasks in parallel.

### Example 14—Example Computing Systems

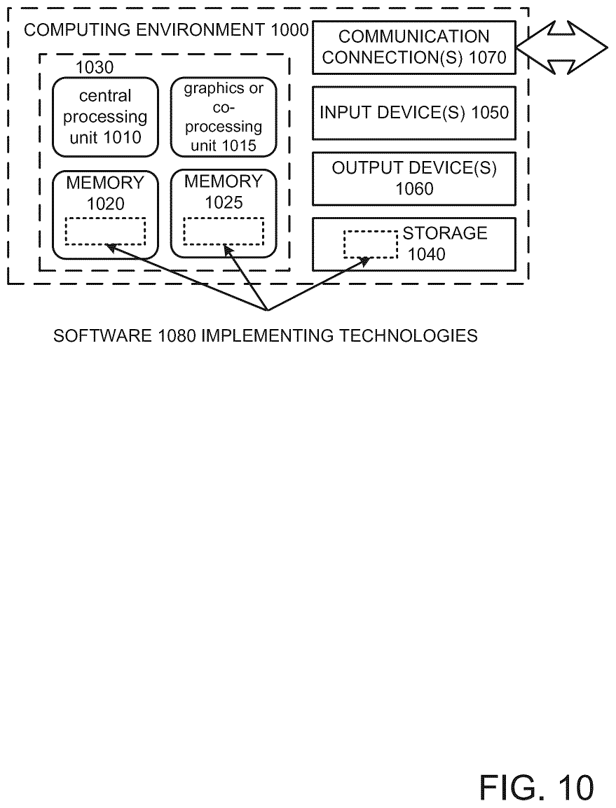

FIG. 10 depicts an example of a suitable computing system 1000 in which the described innovations can be implemented. The computing system 1000 is not intended to suggest any limitation as to scope of use or functionality of the present disclosure, as the innovations can be implemented in diverse computing systems.

With reference to FIG. 10, the computing system 1000 includes one or more processing units 1010, 1015 and memory 1020, 1025. In FIG. 10, this basic configuration 1030 is included within a dashed line. The processing units 1010, 1015 can execute computer-executable instructions, such as for implementing the features described in the examples herein (e.g., the methods 400, 500, 600, 800, 900, 950, etc.). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 10 shows a central processing unit 1010 as well as a graphics processing unit or co-processing unit 1015. The tangible memory 1020, 1025 can be volatile memory (e.g., registers, cache, RAM), non-volatile memory (e.g., ROM, EEPROM, flash memory, etc.), or some combination of the two, accessible by the processing unit(s) 1010, 1015. The memory 1020, 1025 can store software 1080 implementing one or more innovations described herein, in the form of computer-executable instructions suitable for execution by the processing unit(s) 1010, 1015.

A computing system 1000 can have additional features. For example, the computing system 1000 can include storage 1040, one or more input devices 1050, one or more output devices 1060, and one or more communication connections 1070, including input devices, output devices, and communication connections for interacting with a user. An interconnection mechanism (not shown) such as a bus, controller, or network can interconnect the components of the computing system 1000. Typically, operating system software (not shown) can provide an operating environment for other software executing in the computing system 1000, and coordinate activities of the components of the computing system 1000.

The tangible storage 1040 can be removable or non-removable, and includes magnetic disks, magnetic tapes or cassettes, CD-ROMs, DVDs, or any other medium which can be used to store information in a non-transitory way and which can be accessed within the computing system 1000. The storage 1040 can store instructions for the software 1080 implementing one or more innovations described herein.

The input device(s) 1050 can be an input device such as a keyboard, mouse, pen, or trackball, a voice input device, a scanning device, touch device (e.g., touchpad, display, or the like) or another device that provides input to the computing system 1000. The output device(s) 1060 can be a display, printer, speaker, CD-writer, or another device that provides output from the computing system 1000.

The communication connection(s) 1070 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Example 15—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example 16—Example Cloud Computing Environment

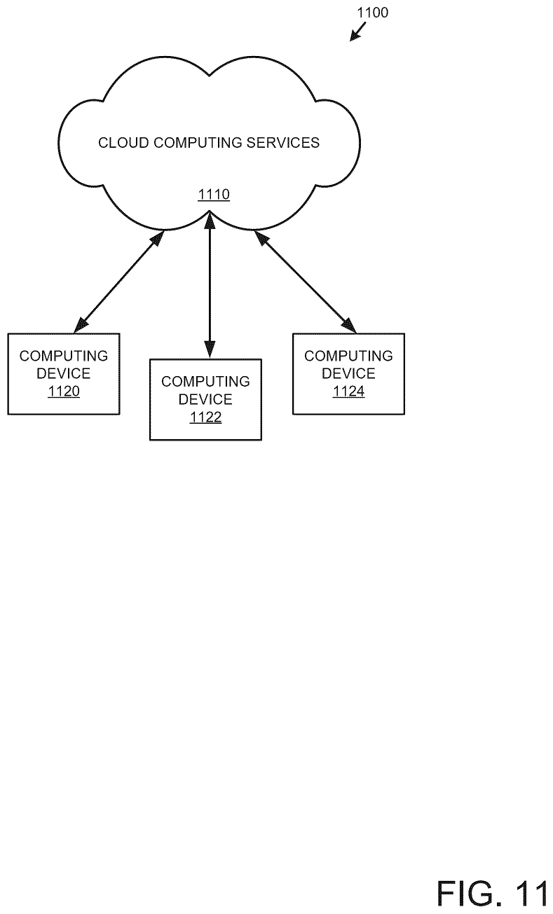

FIG. 11 depicts an example cloud computing environment 1100 in which the described technologies can be implemented, including, e.g., the system 200 and other systems herein. The cloud computing environment 1100 can include cloud computing services 1110. The cloud computing services 1110 can comprise various types of cloud computing resources, such as computer servers, data storage repositories, networking resources, etc. The cloud computing services 1110 can be centrally located (e.g., provided by a data center of a business or organization) or distributed (e.g., provided by various computing resources located at different locations, such as different data centers and/or located in different cities or countries).

The cloud computing services 1110 can be utilized by various types of computing devices (e.g., client computing devices), such as computing devices 1120, 1122, and 1124. For example, the computing devices (e.g., 1120, 1122, and 1124) can be computers (e.g., desktop or laptop computers), mobile devices (e.g., tablet computers or smart phones), or other types of computing devices. For example, the computing devices (e.g., 1120, 1122, and 1124) can utilize the cloud computing services 1110 to perform computing operations (e.g., data processing, data storage, and the like).

In practice, cloud-based, on-premises-based, or hybrid scenarios can be supported.

### Example 17—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### Example 18—Example Embodiments

Any of the following example embodiments can be implemented.

Example 1. A computer-implemented method comprising: for a managed space where a plurality of bins are spatially distributed, receiving a new task which specifies traveling from a first source bin to a first target bin; selecting a task which specifies traveling from a second source bin to a second target bin, wherein the selected task is one of a plurality of existing tasks specifying traveling from respective source bins to respective target bins, calculating a connecting distance to the new task, wherein the connecting distance to the new task is measured from the second target bin to the first source bin; comparing the connecting distance to the new task with connecting distances to candidate tasks of the selected task, wherein the candidate tasks of the selected task are chosen from the plurality of existing tasks that have not been executed based on ranking of their connecting distances, wherein the connecting distance to an existing task is measured from the second target bin to respective source bin of the existing task; responsive to determining that the connecting distance to the new task is smaller than the connecting distance to one of the candidate tasks of the selected task, updating a successor list which identifies the candidate tasks of the selected task, wherein the updating comprises removing one of the candidate tasks of the selected task that has the largest connecting distance from the successor list and adding the new task to the successor list; and responsive to completion of the selected task, selecting a successor task from the successor list to execute, wherein the successor task has the shortest connecting distance among the candidate tasks of the selected task.

Example 2. The method of example 1, wherein the calculating the connecting distance to the new task comprises: determining a first pathway in the managed space where the first source bin is located; determining a second pathway in the managed space where the second target bin is located; and responsive to a determination that the first pathway is different from the second pathway, obtaining one or two first distances from the second target bin to one or two exit nodes of the second pathway; obtaining one or two second distances from one or two entry nodes of the first pathway to the first source bin; obtaining one, two, or four third distances from one of the exit nodes of the second pathway to one of the entry nodes of the first pathway; calculating one, two, or four route distances from the second target bin to the first source bin by respectively summing one of first distances, one of the second distances, and one of the third distances; and selecting the shortest route distance as the connecting distance to the new task.

Example 3. The method of example 2, wherein the third distances are retrieved from a first data buffer, wherein the first data buffer stores pre-calculated distances from exit nodes to entry nodes of a plurality of pathways in the managed space.

Example 4. The method of any one of examples 2-3, wherein the first distances are retrieved from a second data buffer and the second distances are retrieved from a third data buffer, wherein the second data buffer stores pre-calculated distances from the plurality of bins to respective exit nodes of corresponding pathways, wherein the third data buffer stores pre-calculated distances from respective entry nodes of corresponding pathways to the plurality of bins.

Example 5. The method of any one of examples 2-4, wherein responsive to a determination that the first pathway is the same as the second pathway, obtaining a direct distance from the second target bin to the first source bin and setting the connecting distance to the new task to be the direct distance, wherein the direct distance is retrieved from a fourth memory buffer, wherein the fourth memory buffer stores pre-calculated distances between pairs of bins that are located within the same pathways.

Example 6. The method of any one of examples 1-5, further comprising generating a new successor list for the new task, wherein the new successor list identifies candidate tasks of the new task, wherein the candidate tasks of the new task are chosen from the plurality of existing tasks that have not been executed based on ranking of their connecting distances.

Example 7. The method of any one of examples 1-6, further comprising: responsive to starting execution of the selected task, identifying predecessor tasks of the selected task, wherein the predecessor tasks are associated with respective successor lists which identify the selected task as a candidate task; and removing the selected task from the respective successor lists associated with the predecessor tasks.

Example 8. The method of any one of examples 1-7, further comprising: responsive to completion of the selected task, sending a message to a resource who executed the selected task with instructions to travel along a travel path specified by the selected successor task; and deleting the successor list.

Example 9. A computing system, comprising: memory; one or more hardware processors coupled to the memory; and one or more computer readable storage media storing instructions that, when loaded into the memory, cause the one or more hardware processors to perform operations comprising: for a managed space where a plurality of bins are spatially distributed, receiving a new task which specifies traveling from a first source bin to a first target bin; selecting a task which specifies traveling from a second source bin to a second target bin, wherein the selected task is one of a plurality of existing tasks specifying traveling from respective source bins to respective target bins, calculating a connecting distance to the new task, wherein the connecting distance to the new task is measured from the second target bin to the first source bin; comparing the connecting distance to the new task with connecting distances to candidate tasks of the selected task, wherein the candidate tasks of the selected task are chosen from the plurality of existing tasks that have not been executed based on ranking of their connecting distances, wherein the connecting distance to an existing task is measured from the second target bin to respective source bin of the existing task; responsive to determining that the connecting distance to the new task is smaller than the connecting distance to one of the candidate tasks of the selected task, updating a successor list which identifies the candidate tasks of the selected task, wherein the updating comprises removing one of the candidate tasks of the selected task that has the largest connecting distance from the successor list and adding the new task to the successor list; and responsive to completion of the selected task, selecting a successor task from the successor list to execute, wherein the successor task has the shortest connecting distance among the candidate tasks of the selected task.

Example 10. The system of example 9, wherein the operation of calculating the connecting distance for the second task comprises: determining a first pathway in the managed space where the first source bin is located; determining a second pathway in the managed space where the second target bin is located; and responsive to a determination that the first pathway is different from the second pathway, obtaining one or two first distances from the second target bin to one or two exit nodes of the second pathway; obtaining one or two second distances from one or two entry nodes of the first pathway to the first source bin; obtaining one, two, or four third distances from one of the exit nodes of the second pathway to one of the entry nodes of the first pathway; calculating one, two, or four route distances from the second target bin to the first source bin by respectively summing one of first distances, one of the second distances, and one of the third distances; and selecting the shortest route distance as the connecting distance to the new task.

Example 11. The system of example 10, wherein the third distances are retrieved from a first data buffer, wherein the first data buffer stores pre-calculated distances from exit nodes to entry nodes of a plurality of pathways in the managed space.

Example 12. The system of any one of examples 10-11, wherein the first distances are retrieved from a second data buffer and the second distances are retrieved from a third data buffer, wherein the second data buffer stores pre-calculated distances from the plurality of bins to respective exit nodes of corresponding pathways, wherein the third data buffer stores pre-calculated distances from respective entry nodes of corresponding pathways to the plurality of bins.

Example 13. The system of any one of examples 10-12, wherein responsive to a determination that the first pathway is the same as the second pathway, obtaining a direct distance from the second target bin to the first source bin and setting the connecting distance to the new task to be the direct distance, wherein the direct distance is retrieved from a fourth memory buffer, wherein the fourth memory buffer stores pre-calculated distances between pairs of bins that are located within the same pathways.

Example 14. The system of any one of examples 9-13, wherein the operations further comprises generating a new successor list for the new task, wherein the new successor list identifies candidate tasks of the new task, wherein the candidate tasks of the new task are chosen from the plurality of existing tasks that have not been executed based on ranking of their connecting distances.

Example 15. The system of any one of examples 9-14, wherein the operations further comprise: responsive to starting execution of the selected task, identifying predecessor tasks of the selected task, wherein the predecessor tasks are associated with respective successor lists which identify the selected task as a candidate task; and removing the selected task from the respective successor lists associated with the predecessor tasks.

Example 16. The system of any one of examples 9-15, wherein the operations further comprise: responsive to completion of the selected task, deleting the successor list.

Example 17. One or more non-transitory computer-readable media having encoded thereon computer-executable instructions causing one or more processors to perform a method comprising: for a managed space where a plurality of bins are spatially distributed, receiving a new task which specifies traveling from a first source bin to a first target bin; selecting a task which specifies traveling from a second source bin to a second target bin, wherein the selected task is one of a plurality of existing tasks specifying traveling from respective source bins to respective target bins; calculating a connecting distance to the new task, wherein the connecting distance to the new task is measured from the second target bin to the first source bin; comparing the connecting distance to the new task with connecting distances to candidate tasks of the selected task, wherein the candidate tasks of the selected task are chosen from the plurality of existing tasks that have not been executed based on ranking of their connecting distances, wherein the connecting distance to an existing task is measured from the second target bin to respective source bin of the existing task; responsive to determining that the connecting distance to the new task is smaller than the connecting distance to one of the candidate tasks of the selected task, updating a successor list which identifies the candidate tasks of the selected task, wherein the updating comprises removing one of the candidate tasks of the selected task that has the largest connecting distance from the successor list and adding the new task to the successor list; generating a new successor list for the new task, wherein the new successor list identifies candidate tasks of the new task, wherein the candidate tasks of the new task are chosen from the plurality of existing tasks that have not been executed based on ranking of their connecting distances; and responsive to completion of the selected task, selecting a successor task from the successor list to execute, wherein the successor task has the shortest connecting distance among the candidate tasks of the selected task.

Example 18. The one or more non-transitory computer-readable media of example 17, wherein the method further comprises: responsive to completion of the selected task, deleting the successor list.

Example 19. The one or more non-transitory computer-readable media of any one of examples 17-18, wherein the calculating the connecting distance for the second task comprises: determining a first pathway in the managed space where the first source bin is located; determining a second pathway in the managed space where the second target bin is located; and responsive to a determination that the first pathway is different from the second pathway, obtaining one or two first distances from the second target bin to one or two exit nodes of the second pathway; obtaining one or two second distances from one or two entry nodes of the first pathway to the first source bin; obtaining one, two, or four third distances from one of the exit nodes of the second pathway to one of the entry nodes of the first pathway; calculating one, two, or four route distances from the second target bin to the first source bin by respectively summing one of first distances, one of the second distances, and one of the third distances; and selecting the shortest route distance as the connecting distance to the new task, wherein the third distances are retrieved from a first data buffer, wherein the first data buffer stores pre-calculated distances from exit nodes to entry nodes of a plurality of pathways in the managed space.

Example 20. The one or more non-transitory computer-readable media of any one of examples 17-19, wherein the first distances are retrieved from a second data buffer and the second distances are retrieved from a third data buffer, wherein the second data buffer stores pre-calculated distances from the plurality of bins to respective exit nodes of corresponding pathways, wherein the third data buffer stores pre-calculated distances from respective entry nodes of corresponding pathways to the plurality of bins.

### Example 19—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
for a managed space where a plurality of bins are spatially distributed, receiving a new task which specifies traveling from a first source bin to a first target bin;
selecting a task which specifies traveling from a second source bin to a second target bin, wherein the selected task is one of a plurality of existing tasks specifying traveling from respective source bins to respective target bins,
calculating a connecting distance to the new task, wherein the connecting distance to the new task is measured from the second target bin to the first source bin;
comparing the connecting distance to the new task with connecting distances to candidate tasks of the selected task, wherein the candidate tasks of the selected task are chosen from the plurality of existing tasks that have not been executed based on ranking of their connecting distances, wherein the connecting distance to an existing task is measured from the second target bin to respective source bin of the existing task;
responsive to determining that the connecting distance to the new task is smaller than the connecting distance to one of the candidate tasks of the selected task, updating a successor list which identifies the candidate tasks of the selected task, wherein the updating comprises removing one of the candidate tasks of the selected task that has the largest connecting distance from the successor list and adding the new task to the successor list; and
responsive to completion of the selected task, selecting a successor task from the successor list to execute, wherein the successor task has the shortest connecting distance among the candidate tasks of the selected task.

2. The method of claim 1, wherein the calculating the connecting distance to the new task comprises:
determining a first pathway in the managed space where the first source bin is located;
determining a second pathway in the managed space where the second target bin is located; and
responsive to a determination that the first pathway is different from the second pathway,
obtaining one or two first distances from the second target bin to one or two exit nodes of the second pathway;
obtaining one or two second distances from one or two entry nodes of the first pathway to the first source bin;
obtaining one, two, or four third distances from one of the exit nodes of the second pathway to one of the entry nodes of the first pathway;
calculating one, two, or four route distances from the second target bin to the first source bin by respectively summing one of first distances, one of the second distances, and one of the third distances; and
selecting the shortest route distance as the connecting distance to the new task.

3. The method of claim 2, wherein the third distances are retrieved from a first data buffer, wherein the first data buffer stores pre-calculated distances from exit nodes to entry nodes of a plurality of pathways in the managed space.

4. The method of claim 2, wherein the first distances are retrieved from a second data buffer and the second distances are retrieved from a third data buffer, wherein the second data buffer stores pre-calculated distances from the plurality of bins to respective exit nodes of corresponding pathways, wherein the third data buffer stores pre-calculated distances from respective entry nodes of corresponding pathways to the plurality of bins.

5. The method of claim 2, wherein responsive to a determination that the first pathway is the same as the second pathway, obtaining a direct distance from the second target bin to the first source bin and setting the connecting distance to the new task to be the direct distance, wherein the direct distance is retrieved from a fourth memory buffer, wherein the fourth memory buffer stores pre-calculated distances between pairs of bins that are located within the same pathways.

6. The method of claim 1, further comprising generating a new successor list for the new task, wherein the new successor list identifies candidate tasks of the new task, wherein the candidate tasks of the new task are chosen from the plurality of existing tasks that have not been executed based on ranking of their connecting distances.

7. The method of claim 1, further comprising:
responsive to starting execution of the selected task, identifying predecessor tasks of the selected task, wherein the predecessor tasks are associated with respective successor lists which identify the selected task as a candidate task; and
removing the selected task from the respective successor lists associated with the predecessor tasks.

8. The method of claim 1, further comprising:
responsive to completion of the selected task, sending a message to a resource who executed the selected task with instructions to travel along a travel path specified by the selected successor task; and
deleting the successor list.

9. A computing system, comprising:
memory;
one or more hardware processors coupled to the memory; and
one or more computer readable storage media storing instructions that, when loaded into the memory, cause the one or more hardware processors to perform operations comprising:
for a managed space where a plurality of bins are spatially distributed, receiving a new task which specifies traveling from a first source bin to a first target bin;
selecting a task which specifies traveling from a second source bin to a second target bin, wherein the selected task is one of a plurality of existing tasks specifying traveling from respective source bins to respective target bins,
calculating a connecting distance to the new task, wherein the connecting distance to the new task is measured from the second target bin to the first source bin;
comparing the connecting distance to the new task with connecting distances to candidate tasks of the selected task, wherein the candidate tasks of the selected task are chosen from the plurality of existing tasks that have not been executed based on ranking of their connecting distances, wherein the connecting distance to an existing task is measured from the second target bin to respective source bin of the existing task;
responsive to determining that the connecting distance to the new task is smaller than the connecting distance to one of the candidate tasks of the selected task, updating a successor list which identifies the candidate tasks of the selected task, wherein the updating comprises removing one of the candidate tasks of the selected task that has the largest connecting distance from the successor list and adding the new task to the successor list; and
responsive to completion of the selected task, selecting a successor task from the successor list to execute, wherein the successor task has the shortest connecting distance among the candidate tasks of the selected task.

10. The system of claim 9, wherein the operation of calculating the connecting distance for the second task comprises:
determining a first pathway in the managed space where the first source bin is located;
determining a second pathway in the managed space where the second target bin is located; and
responsive to a determination that the first pathway is different from the second pathway,
obtaining one or two first distances from the second target bin to one or two exit nodes of the second pathway;
obtaining one or two second distances from one or two entry nodes of the first pathway to the first source bin;
obtaining one, two, or four third distances from one of the exit nodes of the second pathway to one of the entry nodes of the first pathway;
calculating one, two, or four route distances from the second target bin to the first source bin by respectively summing one of first distances, one of the second distances, and one of the third distances; and
selecting the shortest route distance as the connecting distance to the new task.

11. The system of claim 10, wherein the third distances are retrieved from a first data buffer, wherein the first data buffer stores pre-calculated distances from exit nodes to entry nodes of a plurality of pathways in the managed space.

12. The system of claim 10, wherein the first distances are retrieved from a second data buffer and the second distances are retrieved from a third data buffer, wherein the second data buffer stores pre-calculated distances from the plurality of bins to respective exit nodes of corresponding pathways, wherein the third data buffer stores pre-calculated distances from respective entry nodes of corresponding pathways to the plurality of bins.

13. The system of claim 10, wherein responsive to a determination that the first pathway is the same as the second pathway, obtaining a direct distance from the second target bin to the first source bin and setting the connecting distance to the new task to be the direct distance, wherein the direct distance is retrieved from a fourth memory buffer, wherein the fourth memory buffer stores pre-calculated distances between pairs of bins that are located within the same pathways.

14. The system of claim 9, wherein the operations further comprises generating a new successor list for the new task, wherein the new successor list identifies candidate tasks of the new task, wherein the candidate tasks of the new task are chosen from the plurality of existing tasks that have not been executed based on ranking of their connecting distances.

15. The system of claim 9, wherein the operations further comprise:
responsive to starting execution of the selected task, identifying predecessor tasks of the selected task, wherein the predecessor tasks are associated with respective successor lists which identify the selected task as a candidate task; and
removing the selected task from the respective successor lists associated with the predecessor tasks.

16. The system of claim 9, wherein the operations further comprise:
responsive to completion of the selected task, deleting the successor list.

17. One or more non-transitory computer-readable media having encoded thereon computer-executable instructions causing one or more processors to perform a method comprising:
for a managed space where a plurality of bins are spatially distributed, receiving a new task which specifies traveling from a first source bin to a first target bin;
selecting a task which specifies traveling from a second source bin to a second target bin, wherein the selected task is one of a plurality of existing tasks specifying traveling from respective source bins to respective target bins;
calculating a connecting distance to the new task, wherein the connecting distance to the new task is measured from the second target bin to the first source bin;
comparing the connecting distance to the new task with connecting distances to candidate tasks of the selected task, wherein the candidate tasks of the selected task are chosen from the plurality of existing tasks that have not been executed based on ranking of their connecting distances, wherein the connecting distance to an existing task is measured from the second target bin to respective source bin of the existing task;
responsive to determining that the connecting distance to the new task is smaller than the connecting distance to one of the candidate tasks of the selected task, updating a successor list which identifies the candidate tasks of the selected task, wherein the updating comprises removing one of the candidate tasks of the selected task that has the largest connecting distance from the successor list and adding the new task to the successor list;
generating a new successor list for the new task, wherein the new successor list identifies candidate tasks of the new task, wherein the candidate tasks of the new task are chosen from the plurality of existing tasks that have not been executed based on ranking of their connecting distances; and
responsive to completion of the selected task, selecting a successor task from the successor list to execute, wherein the successor task has the shortest connecting distance among the candidate tasks of the selected task.

18. The one or more non-transitory computer-readable media of claim 17, wherein the method further comprises:
responsive to completion of the selected task, deleting the successor list.

19. The one or more non-transitory computer-readable media of claim 17, wherein the calculating the connecting distance for the second task comprises:
determining a first pathway in the managed space where the first source bin is located;
determining a second pathway in the managed space where the second target bin is located; and
responsive to a determination that the first pathway is different from the second pathway,
obtaining one or two first distances from the second target bin to one or two exit nodes of the second pathway;
obtaining one or two second distances from one or two entry nodes of the first pathway to the first source bin;
obtaining one, two, or four third distances from one of the exit nodes of the second pathway to one of the entry nodes of the first pathway;
calculating one, two, or four route distances from the second target bin to the first source bin by respectively summing one of first distances, one of the second distances, and one of the third distances; and
selecting the shortest route distance as the connecting distance to the new task,
wherein the third distances are retrieved from a first data buffer, wherein the first data buffer stores pre-calculated distances from exit nodes to entry nodes of a plurality of pathways in the managed space.

20. The one or more non-transitory computer-readable media of claim 17, wherein the first distances are retrieved from a second data buffer and the second distances are retrieved from a third data buffer, wherein the second data buffer stores pre-calculated distances from the plurality of bins to respective exit nodes of corresponding pathways, wherein the third data buffer stores pre-calculated distances from respective entry nodes of corresponding pathways to the plurality of bins.
